(19) United States
(12) Patent Application Publication
(10) Pub. No.: US 2026/0313550 A1
(43) Pub. Date: Oct. 8, 2026

(54) FREQUENCY DIVERSITY FOR LOW POWER WAKE-UP SIGNALS

(71) Applicant: Apple Inc., Cupertino, CA (US)

(72) Inventors: Sigen Ye, San Diego, CA (US); Haitong Sun, Cupertino, CA (US); Dawei Zhang, Saratoga, CA (US); Yang Tang, San Jose, CA (US); Wei Zeng, Saratoga, CA (US)

(21) Appl. No.: 19/478,909

(22) PCT Filed: Mar. 22, 2024
(86) PCT No.: PCT/US2024/021062

§ 371 Date: Oct. 27, 2025

Related U.S. Application Data
(60) Provisional application No. 63/501,708, filed on May 12, 2023.

(51) Int. Cl. H04W 52/02; H04W 72/0446

(52) U.S. Cl. CPC H04W 52/0235; H04W 72/0446

(57) ABSTRACT

Systems, methods, processors, and circuitries are provided for supporting frequency diversity in wake-up signals. In one example, a method for a user equipment includes receiving a wake-up signal (WUS) carrying multiple encoded bits based on one or more information bits of a wake-up message. The WUS comprises a plurality of signal components, each signal component carrying one or more encoded bits. At least two of the plurality of signal components are received in different frequency segments comprising different sets of frequency resources. In response to the WUS, one or more components of the UE are configured to receive subsequent signals.

### REFERENCE TO RELATED APPLICATIONS

This application claims the benefit of U.S. Provisional Application No. 63/501,708, filed on May 12, 2023, the contents of which are hereby incorporated by reference in their entirety

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) and network devices, such as base stations, to communicate with one another. A feature of such networks and devices may include power saving measures in which a UE operates in a low power state until notified by the network of impending downlink communication.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1A is a block diagram of an example UE that includes a primary receiver and a low power receiver, according to various aspects disclosed herein.

FIG. 1B is a timeline diagram of a UE operating in a power saving mode, according to various aspects disclosed herein.

FIG. 2 illustrates an example wake-up signal (WUS), according to various aspects disclosed herein.

FIG. 3 illustrates an example WUS encoding system, according to various aspects disclosed herein.

FIG. 4 illustrates an example WUS encoding system, according to various aspects disclosed herein.

FIG. 5 illustrates an example WUS encoding system, according to various aspects disclosed herein.

FIG. 6 illustrates an example WUS encoding system, according to various aspects disclosed herein.

FIG. 7 illustrates an example WUS encoding system, according to various aspects disclosed herein.

FIG. 8 is a flow diagram outlining an example method for processing a WUS, according to various aspects disclosed herein.

FIG. 9 is a flow diagram outlining an example method for transmitting a WUS, according to various aspects disclosed herein.

FIG. 10 is a diagram of an example wireless network, according to various aspects disclosed herein.

FIG. 11 is a diagram of an example of components of a device according to various aspects disclosed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

A UE operating within a wireless network may be in one of a number of states. For example, radio resource control (RRC)-CONNECTED state refers to a state where the UE and the base station are connected and the UE is available for exchanging information with the base station. RRC-IDLE refers to a state in which the UE is not exchanging information with a base station, but the UE takes steps to find and maintain a service connection with the base station. RRC-INACTIVE refers to a sate where a UE remains connected with an Access Management Function (AMF) and can move within an area configured by the network without notifying the network.

When the UE is in the RRC-IDLE or RRC-INACTIVE state, the UE may enter a sleep state in which selected UE components (e.g., a baseband processor, primary receiver, and so on) are powered off or put into a low power consumption mode to conserve power. While in the sleep state, the UE may monitor for wake-up signals (WUSs) that alert the UE that it should change its operating mode to enable the UE to receive a subsequent signal. The subsequent signal may be, for example, a physical downlink control channel (PDCCH) transmission indicating that a communication will be transmitted to the UE, a reference signal for cell selection or tracking purposes, system information, and so on. Upon receiving a WUS, the components powered off during sleep may be powered back on to receive the subsequent signal.

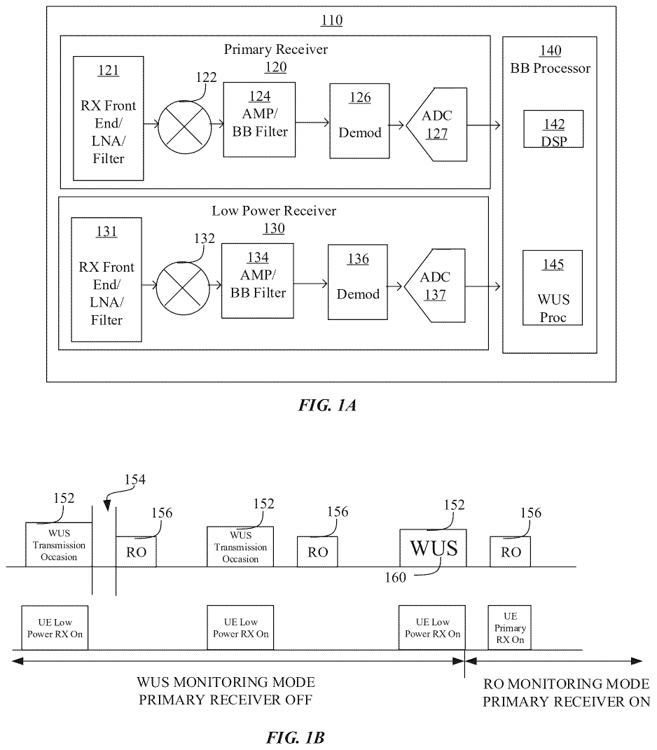

FIG. 1A is a block diagram of an example UE 110 that includes a primary receiver 120, a low power receiver 130, and a baseband processor 140. The primary receiver 120 includes a receiver front end 121, a downconverter 122, an amplifier/baseband filter 124, a demodulator 126, and an analog-to-digital convertor 127. The front end 121 may include a filter and/or a low noise amplifier (LNA) configured to receive an RF signal and amplify the received RF signal for further processing. The downconverter 122 may include circuitry configured to receive the output of the front end 121 and downconvert the RF signal using a local oscillator (LO) signal to either an intermediate frequency (IF) or to a baseband or near-baseband signal for further processing. The demodulator 126 may be configured to demodulate the received signal to recover the encoded information signal (e.g., data or payload). The ADC may be configured to convert the analog signal from the demodulator to digital signals. The output of the ADC 127 is provided to the baseband processor 140 for further processing.

The low power receiver 130 (also referred in some contexts as a WUS receiver) includes a receiver front end 131, a downconverter 132, an amplifier/baseband filter 134, a demodulator 136, and an analog-to-digital convertor 137. The front end 131 may include a filter and/or a low noise amplifier (LNA) configured to receive a WUS signal and amplify the received WUS signal for further processing. The downconverter 132 may include circuitry configured to receive the output of the front end 131 and downconvert the RF signal using a local oscillator (LO) signal to either an intermediate frequency (IF) or to a baseband or near-baseband signal for further processing. The demodulator 136 may be configured to demodulate the received signal to recover the encoded information signal (e.g., a wake-up message or information bits). The ADC may be configured to convert the analog signal from the demodulator to digital signals. The output of the ADC 137 is provided to the baseband processor 140 for further processing. It is noted that the architecture of the low power receiver 130 is just one example, and there may be other low power receiver architectures capable of utilizing the disclosed solutions.

The baseband processor includes a digital signal processor (DSP) 142 and a wake-up signal (WUS) processor 145. The DSP 142 is configured to perform one or more digital processing operations to convert the digital information signal received fro the ADC 127 to a usable data signal. The WUS processor 145 is configured to perform one or more digital processing operations to convert the digital information signal received from the ADC 137 to a signal that may be used to determine whether the primary receiver 120 and parts of the baseband processor 140 not used for WUS processing should be activated to process subsequently received signals (e.g., PDCCH, reference signals, system information, and so on).

In some examples, the low power receiver 130 may be implemented as a separate receiver from the primary receiver 120 (e.g., using a self-contained set of hardware components) as illustrated in FIG. 1A. In other examples, the low power receiver may include a portion of the primary receiver with processing capability tailored to process WUSs. Accordingly, the low power receiver 130 may be efficient from a power consumption perspective because it need only process a relatively small WUS payload size (e.g., having a single bit or a few bits) and/or a simple waveform. Further, because the WUS payload size may be small, the portion of the baseband processor resources used to process the WUS (e.g., the WUS processor 145) may be small compared to the overall processing capability of the baseband processor 140 and/or the DSP 142.

FIG. 1B illustrates a timeline overview of operational status of a UE that monitors for WUS using a low power receiver. The UE is configured to monitor time and frequency resources corresponding to WUS transmission occasions 152. A number of receive opportunities (ROs) 156 are indicated in FIG. 1B. An RO is a general term for time and frequency resources allocated for paging (i.e., a paging occasion), PDCCH, reference signals, system information blocks, or any other communication that the UE should power up the primary receiver 120 to receive. The respective transmission occasions 152 are configured to precede a respective receive opportunity RO 156 by a gap 154. The gap 154 has a duration that is selected based on a time it takes for the primary receiver 120 to power on and be able to receive the expected subsequent signaling (e.g., PDCCH, reference signals, system information blocks, and so on). While the UE is in WUS monitoring mode, the primary receiver 120 and, as disclosed above, significant portions of the baseband processor are powered off or are in a very low power state. The UE low power receiver 130 is powered on to monitor each WUS transmission occasion 152. If no WUS is detected, the low power receiver may be powered down until the next WUS transmission occasion 152.

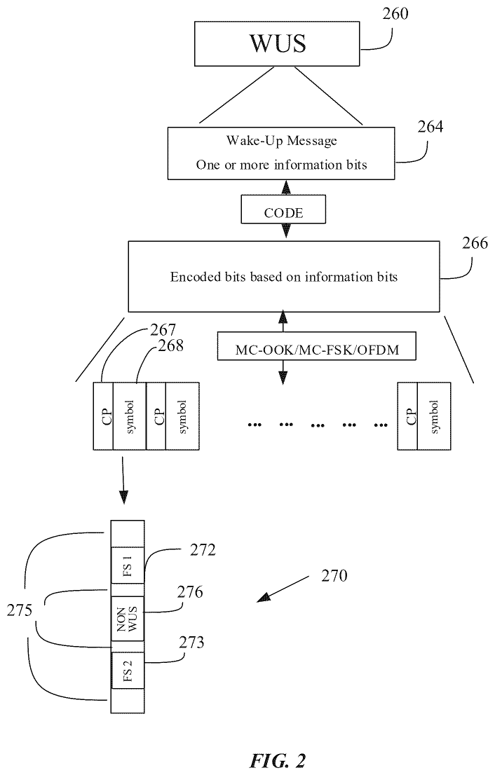

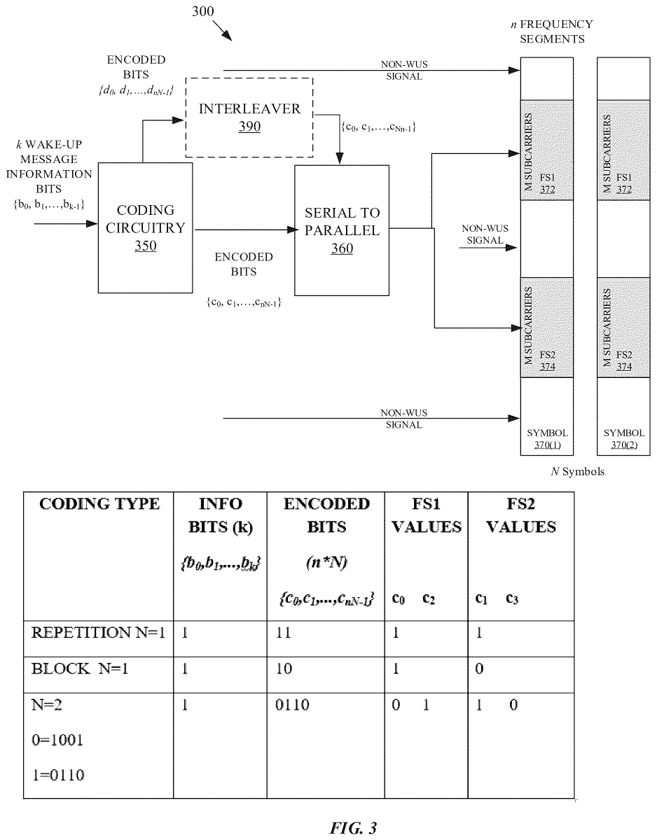

FIG. 2 illustrates an example of a WUS 260. The WUS 260 includes one or more information bits corresponding to a wake-up message. The information bits may be coded (e.g., repetition, block code, and so on) to generate encoded bits 266. The sequence of encoded bits is modulated onto symbols. For example, the encoded bits may be modulated into a sequence of orthogonal frequency division multiplexing (OFDM) symbols, with each OFDM symbol including a cyclic prefix portion 267 and a symbol portion 268. To simplify the processing necessary to decode the WUS, on-off keying (OOK) modulation may be used. In OOK modulation, for each encoded bit, to communicate a value of zero no transmission is made on subcarrier(s) allocated to the WUS during the symbol portion 268 and to communicate a value of one, some signal is transmitted on the subcarriers allocated to the WUS during the symbol portion 268. This simplifies decoding because the receiver does not need to determine which particular signal is being transmitted but only whether any signal is being transmitted on the subcarriers allocated to the WUS (e.g., a certain level of energy is detected during the symbol portion 268).

In some examples, to support frequency diversity for WUS, each symbol portion 268 includes multiple frequency segments for transmission of WUS (two frequency segments 272, 273 are shown in the illustrated example). The frequency segments include different sets of contiguous subcarriers. If the WUS is multiplexed with other signals in the frequency domain in the same OFDM symbol, to reduce interference between the WUS and other signals (e.g., non-WUS signal 276) carried by the symbol, guard bands 275 (sets of contiguous subcarriers) may be included in the WUS configuration. To facilitate reception of WUS having multiple signal components carried by the multiple frequency segments, the low power receiver front end may include a filter for each frequency segment configured to filter out signals having frequencies surrounding the frequency segment. For the purposes of this disclosure a frequency segment carries a respective signal component of a WUS.

Returning to FIG. 1B, when a WUS 160 is detected during a WUS transmission occasion 152, the UE enters an RO monitoring mode and attempts to receive and decode a signal that is received during a subsequent RO 156. In the RO monitoring mode, the UE configures its components to receive signaling in a subsequent RO 156. In some examples, configuring components to receive signaling includes waking up the primary receiver 120. In some examples, while in RO monitoring mode sufficient, but not full, additional receiving and processing capabilities (as compared to WUS monitoring mode) are enabled in the UE while not all components necessary for normal RRC-CONNECTED mode operation are powered on. Any of these scenarios, in which additional components are powered on or processing power is increased as compared to during WUS monitoring mode, may be referred to herein as “waking up the primary receiver” or “operating in RO monitoring mode”.

In this manner, significant portions of the baseband processor 140 may be powered down or placed in a power saving state when the WUS processor 145 is monitoring for WUS. This may result in significant power savings and extended battery life especially for a UE that receives downlink (DL) communication only occasionally.

WUS may be designed to improve the likelihood that a low power receiver is able to detect and decode the WUS. For example, the WUS should be relatively simple and exhibit resistance to time or frequency impairments to allow lower performance RF components and simple baseband processing to be used.

However, due to the reduced reception capabilities of low power receivers, WUS may be susceptible to reduced coverage as compared to non-WUS signals that will be received using the primary receiver.

Disclosed herein are systems, processors, and methods for incorporating frequency diversity in WUS. This increases the robustness of the WUS without significantly increasing overhead, making the disclosed techniques well-suited for low power WUS. Disclosed are multi-carrier on-off-keying (MC-OOK) modulation, MC-frequency shift keying (MC-FSK) modulation, and orthogonal frequency division multiplexing (OFDM)-based solutions.

In multi-carrier on-off-keying (MC-OOK) modulation, the encoded bits of the wake-up message are modulated such that when a bit value of 1 is being transmitted the subcarriers of frequency segment are modulated with some symbols. When a bit value of 0 is being transmitted the subcarriers of the frequency segment are zero power (e.g., from a baseband point of view). MC-OOK modulation simplifies detection because the receiver needs to only determine if a symbol is carrying signal power (e.g., above a threshold) or not to determine whether a 1 or 0 is being transmitted.

In multi-carrier frequency shift keying (MC-FSK), two frequency segments are used to transmit each bit. For a bit value of 1, the signal is transmitted in one of the frequency segments and for a bit value of 0, the signal is transmitted on another frequency segment.

For orthogonal frequency division multiplexing (OFDM)-based WUS, the UE detects whether a desired sequence or sequences are transmitted.

### Distributed Transmission

In a distributed transmission technique, different components of the WUS are carried by multiple frequency segments within the same OFDM symbol 270. FIG. 3 illustrates an example WUS encoding system 300 that encodes a wake-up message having k information bits into a WUS carried by a plurality of frequency segments within one or more OFDM symbols 370. The system 300 may be used for encoding MC-OOK-based WUSs. Each OFDM symbol 370 includes two frequency segments FS1 372 and FS2 374. Each frequency segment includes M subcarriers. Non-WUS signals may be carried by the remaining subcarriers of the OFDM symbols.

The system includes coding circuitry 350 and serial to parallel circuitry 360. The coding circuitry 350 receives k information bits {b₀, b₁, . . . , bₖ₋₁} and encodes the k information bits into multiple encoded bits. The coding scheme used by the coding circuitry 350 is selected to produce a number of encoded bits that is based on a number of frequency segments per symbol n (e.g., n=2 in the illustrated example) and a number of symbols N that will be used to carry the WUS. In some examples, the sequence of encoded bits {c₀, c₁, . . . c_{nN-1}} has k subsets, with each subset corresponding to one of the information bits. The serial to parallel circuitry 360 distributes an encoded bit to the M subcarriers of one of the frequency segments 372 or 374. Since MC-OOK is used to modulate the bits, if the bit value is one, any symbol values may be carried by subcarriers of the frequency segment and if the bit value is zero, zero signal power will be carried by the subcarriers of the frequency segment.

The table in FIG. 3 illustrates a few example encoding scenarios. The examples are for a single bit wake-up message with simple coding techniques. In other examples, the wake-up message includes multiple bits and the coding may be more sophisticated. The first row of the table summarizes encoding when a repetition coding is used, with a number of repetitions being two and a number of symbols N being one. For a simple one bit wake-up message having a bit value 1, the encoded bits will be 11. For a bit value 0, the encoded bits will be 00 (not shown). The subcarriers in frequency segment FS1 372 will carry any symbol values (to indicate a value of 1 in MC-OOK) for c₀ and the subcarriers in frequency segment FS2 374 will also carry any symbol values for c₁. One drawback to the use of repetition coding is that either all the subcarriers in the WUS frequency segments are carrying some symbol value in each OFDM symbol or all the subcarriers in the frequency segments are carrying zero power in the same OFDM symbol. The base station may not be able to use the unused power in one OFDM symbol for another OFDM symbol.

The second row of the table summarizes encoding when a block code is used in which each information bit is encoded in two bits: a first bit equal to the information bit and a second bit equal to the opposite value of the information bit. The number of symbols N is one. For the one bit wake-up message having a bit value of 1, the encoded bits will be 10. For a bit value of 0, the encoded bits will be 01 (not shown). The subcarriers in frequency segment FS1 372 will carry any symbol values for c₀ and the subcarriers in frequency segment FS2 374 will carry zero power for c₁. Use of a block code or other more sophisticated coding scheme (as compared to simple repetition) allows for different bit values to be carried in the same symbol which may allow the base station to support power boosting on the transmitted subcarriers. The base station may maintain the same total transmit power in a given OFDM but with some subcarriers (those in frequency segments carrying a bit value of 1) power boosted and some subcarriers (those in frequency segments carrying a bit value of 0) with zero power.

The third row of the table summarizes encoding when a channel code is used in which each information bit is encoded in four bits as shown in the first column. The number of symbols N is two for this row. For the one bit wake-up message having a bit value of 1, the encoded bits will be 0110. In the first symbol 370(1), the subcarriers in frequency segment FS1 372 will carry zero power for c₀ and the subcarriers in frequency segment FS2 374 will carry any symbol values for c₁. In the second symbol 370(2), the subcarriers in frequency segment FS1 372 will carry any symbol values for c₂ and the subcarriers in frequency segment FS2 374 will carry zero power for c₃.

To accomplish frequency diversity, the coding performed by coding circuitry 350 on the information bits causes encoded bits be transmitted on at least two different frequency segments. In some examples, each information bit is encoded in at least two bits which are carried by subcarriers in at least two different frequency segments in the same symbol. The coding may correspond to, for example, a computer generated code for small k and n, a simplex code, a Reed-Muller code, a Reed Solomon code, a polar code, or a low density parity code (LDPC), or any code that may maximize the minimum Hamming distance.

In some examples, the encoding system 300 includes interleaver circuitry 390 that interleaves encoded bits output by the coding circuitry {d₀, d₁, . . . , d_{nN-1}} to generate interleaved encoded bits {c₀, c₁, . . . c_{nN-1}}. The interleaved encoded bits are distributed to the frequency segments of one or more symbols as described above. The interleaver 390 performs a random reordering of the sequence of encoded bits output by the coding circuitry 350 to reduce the probability that an erasure channel (e.g., consecutive errors across multiple frequency segments) occurs.

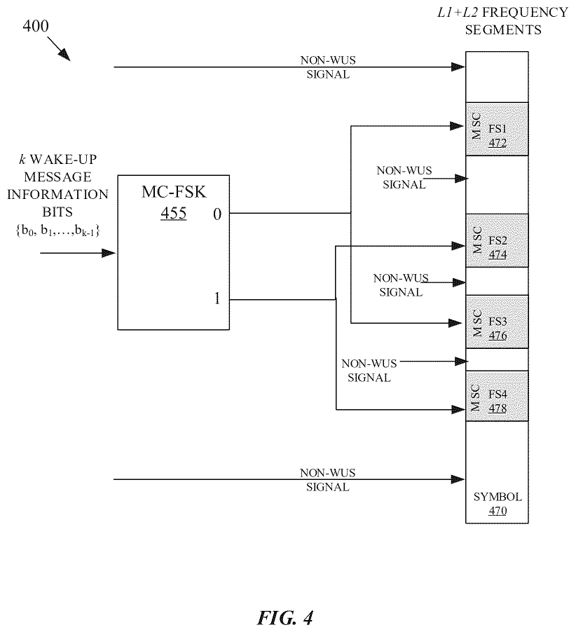

FIG. 4 illustrates an example encoding system 400 that produces an MC-FSK-based WUS signal. In MC-FSK, a number of frequency segments L1 are used to carry a bit value of 0 and a number of frequency segments L2 are used to carry a bit value of 1. For distributed transmission, L1 and L2 must each be at least 2. In some examples, L1=L2 so that bit values of 0 and 1 are equally protected against frequency selectivity. The L1 frequency segments should be spread apart from one another as should the L2 frequency segments to achieve frequency diversity.

The system includes an MC-FSK circuitry 455 that distributes wake-up message bits to frequency segments designated to carry the bit value. In the illustrated example L1=L2=2. L1 frequency segments FS1 472 and FS3 476 are designated for carrying a bit value of 0 and L2 frequency segments FS2 474 and FS4 478 are designated for carrying a bit value of 1. For each information bit the MC-FSK circuitry repeats the bit L times and distributes the bit to the subcarriers in either the L1 or L2 frequency segments.

In general, using MC-FSK to modulate a k bit wake-up message requires k (L1+L2) frequency segments. The encoding techniques (e.g., repetition, block, arbitrary channel coding, and so on) and optional interleaving disclosed with reference to FIG. 3 may be used to generate a larger number of encoded bits or interleaved encoded bits that are distributed by the MC-FSK as described for the information bits.

For distributed transmission with an OFDM-based WUS signal, the WUS may use multiple frequency segments for transmission. The subcarriers in the different frequency segments may carry the same symbols or different symbols. For example, the symbols carried by the subcarriers in different frequency segments may correspond to different sequences to randomize interference, or the base station may apply different precoders in different frequency segments to add spatial diversity.

### Frequency Hopping

As compared to distributed transmission, in a frequency hopping technique, fewer frequency segments are included in each OFDM symbol and different frequency segments are provided in each OFDM symbol in a sequence of OFDM symbols carrying the WUS. In some examples, a single frequency segment is provided in each OFDM symbol and the subcarriers contained in frequency segments in adjacent or consecutive OFDM symbols are different. As compared to the distributed transmission techniques, frequency hopping WUS may allow for simpler low power receivers as less filtering is required to process each OFDM symbol.

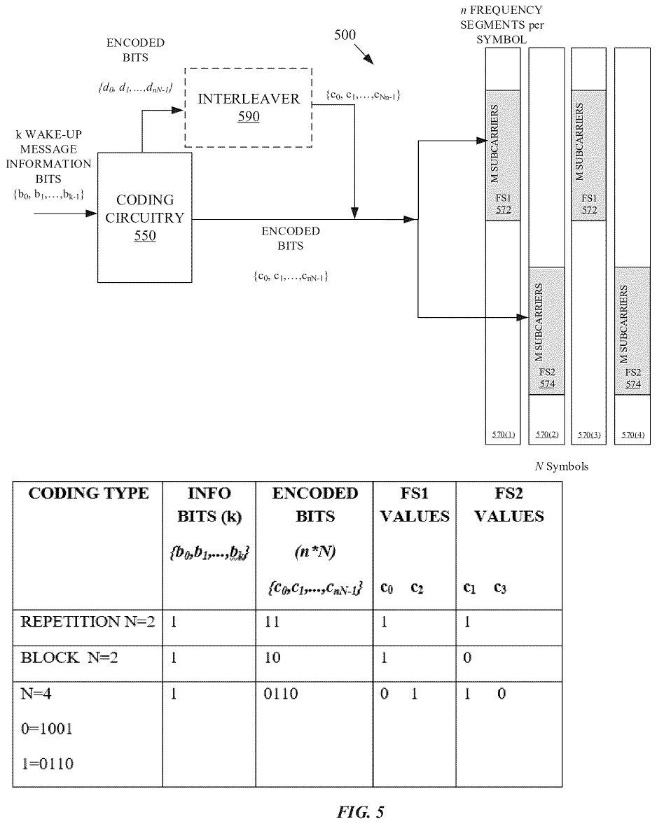

FIG. 5 illustrates an example WUS encoding system 500 that encodes a wake-up message having k information bits into a WUS carried by a plurality of frequency segments within two or more OFDM symbols 570. Each OFDM symbol 570 includes a single frequency segment, either FS1 572 or FS2 574. Each frequency segment includes M subcarriers. Non-WUS signals may be carried by the remaining subcarriers of the OFDM symbols. The example of FIG. 5 is an adaptation of the example of FIG. 3 to show the difference between distributed transmission and frequency hopping for WUS. The system 500 may be used for encoding MC-OOK-based WUSs in a frequency-hopping manner.

The system 500 includes coding circuitry 550. The coding circuitry 550 receives k information bits {b₀, b₁, . . . , bₖ₋₁} and encodes the k information bits into multiple encoded bits. The coding scheme used by the coding circuitry 550 is selected to produce a number of encoded bits that is based on a number of frequency segments per symbol n (e.g., n=1 in the illustrated example) and a number of symbols N that will be used to carry the WUS. In some examples, the sequence of encoded bits {c₀, c₁, . . . . C_{nN-1}} has k subsets, with each subset corresponding to one of the information bits. The coding circuitry provides an encoded bit to the M subcarriers of one of the frequency segments 572 or 574 of one of the OFDM symbols. Since MC-OOK is used to modulate the bits, if the bit value is one, any symbol values may be carried by subcarriers of the frequency segment and if the bit value is zero, zero signal power will be carried by the subcarriers of the frequency segment.

The table in FIG. 5 illustrates a few example encoding scenarios. The examples are for a single bit wake-up message with simple coding techniques. In other examples, the wake-up message includes multiple bits and the coding may be more sophisticated. The first row of the table summarizes encoding when a repetition coding is used, with a number of repetitions being two and a number of symbols N being two. For a simple one bit wake-up message having a bit value 1, the encoded bits will be 11. The subcarriers of frequency segment FS1 572 of OFDM symbol 570(1) will carry any symbol values (to indicate a value of 1 in MC-OOK) for c₀ and the subcarriers of frequency segment FS2 574 of OFDM symbol 570(2) will also carry any symbol values for c₁.

The second row of the table summarizes encoding when a block code is used in which each information bit is encoded in two bits: a first bit equal to the information bit and a second bit equal to the opposite value of the information bit. The number of symbols N is two. For the one bit wake-up message having a bit value of 1, the encoded bits will be 10. The subcarriers of frequency segment FS1 572 of OFDM symbol 570(1) will carry any symbol values for c₀ and the subcarriers of frequency segment FS2 574 of OFDM symbol 570(2) will carry zero power for c₁.

The third row of the table summarizes encoding when a channel code is used in which each information bit is encoded in four bits as shown in the first column. The number of symbols N is four for this row. For the one bit wake-up message having a bit value of 1, the encoded bits will be 0110. In the first symbol 570(1) the subcarriers of frequency segment FS1 572 will carry zero power for c₀. In the second symbol 570(2) the subcarriers of frequency segment FS2 574 will carry any symbol values for c₁. In the third symbol 570(3) the subcarriers of frequency segment FS1 572 will carry any symbol values for c₂. In the fourth symbol 570(4) the subcarriers of frequency segment FS2 574 will carry zero power for c₃.

To accomplish frequency diversity, the coding performed by coding circuitry 550 on the information bits causes encoded bits to be transmitted on at least two different frequency segments. In some examples, each information bit is encoded into at least two bits which are carried by subcarriers in at least two different frequency segments in different symbols. While the illustrated frequency hopping examples include a single frequency segment per symbol, in other examples multiple frequency segments may be used in one symbol. The coding may correspond to, for example, a computer generated code for small k and n, a simplex code, a Reed-Muller code, a Reed Solomon code, a polar code, or a low density parity code (LDPC), or any code that may maximize the minimum Hamming distance.

In some examples, the encoding system 500 includes interleaver circuitry 590 that interleaves encoded bits output by the coding circuitry {d₀, d₁, . . . , d_{nN-1}} to generate interleaved encoded bits {c₀, c₁, . . . c_{nN-1}}. The interleaved encoded bits are distributed to the frequency segments of one or more symbols as described above. The interleaver 490 performs a random reordering of the sequence of encoded bits output by the coding circuitry 550 to reduce the probability that an erasure channel (e.g., consecutive errors across multiple frequency segments) occurs.

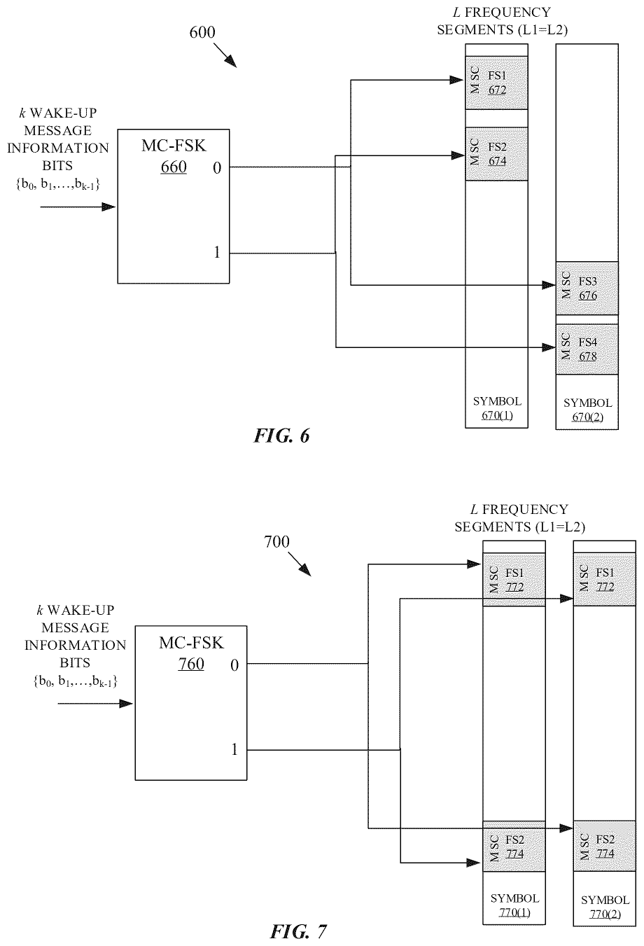

FIGS. 6 and 7 illustrates example encoding systems that produce an MC-FSK-based WUS signal. In MC-FSK, a number L1 of frequency segments are used to carry a bit value of 0 and a number L2 of frequency segments are used to carry a bit value of 1. Thus MC-FSK provides frequency diversity when L1 and L2 are at least two. In some examples, L1=L2 so that bit values of 0 and 1 are equally protected against frequency selectivity. The L1 frequency segments should be spread apart from one another as should the L2 frequency segments to achieve frequency diversity.

Referring now to FIG. 6, an example encoding system 600 includes an MC-FSK circuitry 655 that distributes wake-up message bits to frequency segments designated to carry the bit value over at least two OFDM symbols. In the illustrated example L1=L2=2. L1 frequency segments FS1 672 of OFDM symbol 670(1) and FS3 676 of OFDM symbol 670(2) are designated for carrying a bit value of 0. L2 frequency segments FS2 674 of OFDM symbol 670(1) and FS4 678 Of OFDM symbol 670(2) are designated for carrying a bit value of 1. For each information bit the MC-FSK circuitry repeats the bit L times and distributes the bit to the subcarriers in either the L1 or L2 frequency segments.

In the example illustrated in FIG. 6, the L1 frequency segments (FS1 and FS3) are different from the L2 frequency segments (FS2 and FS4). FIG. 7 illustrates an encoding system 700 in which the L1 frequency segments and the L2 frequency segments are the same (FS1 and FS2) across the symbols but different within each symbol. The encoding system 700 includes an MC-FSK circuitry 755 that distributes wake-up message bits to frequency segments designated to carry the bit value over at least two OFDM symbols. In the illustrated example L1=L2=2. L1 frequency segments FS1 772 of OFDM symbol 770(1) and FS2 774 of OFDM symbol 770(2) are designated for carrying a bit value of 0. L2 frequency segments FS2 774 of OFDM symbol 670(1) and FS1 772 of OFDM symbol 670(2) are designated for carrying a bit value of 1. For each information bit the MC-FSK circuitry repeats the bit L times and distributes the bit to the subcarriers in either the L1 or L2 frequency segments.

In this example, using MC-FSK to modulate a k bit wake-up message requires k (L1+L2) frequency segments spread across N=k (L1+L2)/n symbols. The encoding techniques (e.g., repetition, block, arbitrary channel coding, and so on) and optional interleaving disclosed with reference to FIG. 5 may be used to generate a larger number of encoded bits or interleaved encoded bits that are distributed by the MC-FSK as described for the information bits.

Frequency hopping may be used for OFDM-based WUS. For a sequence based WUS, the UE detects whether a desired sequence is carried in the subcarriers of the frequency segments. The WUS may be transmitted in different frequency segments of different OFDM symbols. The subcarriers in the different frequency segments may carry the same symbols or different symbols. For example, the symbols carried by the subcarriers in different frequency segments of different OFDM symbols may correspond to different sequences to randomize interference, or the base station may apply different precoders in different frequency segments to add spatial diversity. Proper coding may be applied so that encoded bits corresponding to a same input bit are distributed across at least two different frequency segments.

### Frequency Hopping Design

For frequency hopping WUS, the network may configure the UE to monitor specific frequency segments in each OFDM symbol of a sequence of OFDM symbols. Assuming that there are F total number of frequency segments in one OFDM symbol, the network may configure a particular frequency segment f=0, 1, 2, . . . , f_{N-1} for monitoring in each consecutive OFDM symbol in the sequence. The configuration may be communicated to the UE by way of dedicated signaling with the UE (e.g., UE dedicated RRC or media access control (MAC) control element (CE)) or broadcasted by way of, for example, system information. The techniques disclosed below apply to MC-OOK, MC-FSK, or OFDM-based signals. For MC-FSK the disclosed techniques may be applied to the frequency segments representing 0 or 1 separately.

For each time domain transmission occasion (e.g., symbol) identified by symbol index I, the frequency segment used in the symbol I may be calculated as

$$( f + O ( I ) ) mod F \qquad EQ . 1$$

where mod is the modulo operation and O(I) is a frequency segment offset calculated based on the time domain transmission occasion index I. The time domain transmission occasion index I may be determined with respect to some relative time reference, such as the start of the WUS. In this example, if the WUS includes L symbols, for each symbol the corresponding time domain transmission occasion index I=0, 1, . . . , L−1.

In another example, the time domain transmission occasion index I is calculated with respect to some absolute time reference. The absolute time reference may be an absolute symbol index within a slot so that I restarts at the beginning of each slot. The absolute time reference may be an absolute symbol index within a radio frame so that I restarts at the beginning of each radio frame. The absolute time reference may be an absolute symbol index within a cycle of 1024 radio frames so that I restarts at the beginning of each radio frame with system frame number (SFN)=0. A time domain transmission occasion index may contain one or multiple OFDM symbols.

The frequency offset as a function of time domain transmission occasion index O(I) may be calculated in a number of ways. In one example

$$O ( I ) = P * I \qquad EQ . 2$$

in which P is a prime number. Using a prime number allows for a maximum cyclic length with the modulo operation. For example, if P=5 and F=8, O(I) follows the sequence {0,5,2,7,4,1,6,3,0 . . . }. The prime number may be configured by the network or hardcoded based on 3GPP specification.

In another example, O(I) is calculated based on a pseudo-random sequence c (n), (e.g., a binary Gold sequence calculated based on 3GPP standard). In this example ┌log₂ F┐ bits can be sequentially taken from c (n) to calculate O(I) for time domain transmission occasion I. The sequence may be initialized based on one or more of the following factors: the symbol index within the slot, the slot index within the radio frame, the system frame number, or the symbol index within the WUS signal.

In other examples, O(I) is predefined. For example O(I) may follow the sequence {0,1,2,3,4,5,6,7,8,0 . . . } or {0,4,2,6,1,5,3,7,0, . . . }.

WUS encoding techniques are disclosed above and illustrated in FIGS. 3-7. The UE receiving the WUS (e.g., UE 110 with low power receiver 130 of FIG. 1A) is configured to receive, filter, combine, re-order, demodulate, and/or decode the WUS in a corresponding manner to recover the wake-up message.

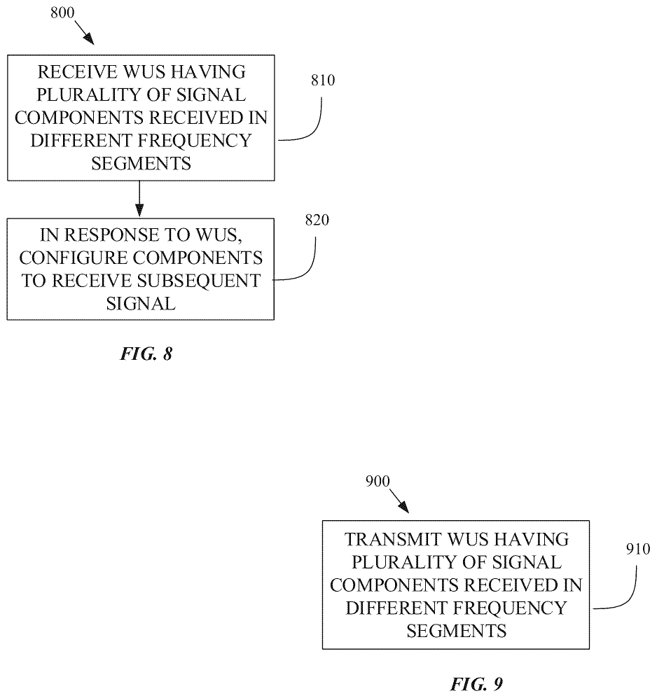

FIG. 8 is a flow diagram outlining an example method 800 for processing a WUS. The method 800 may be performed by a UE (e.g., UE 110 of FIG. 1A). The method includes, at 810, receiving a wake-up signal (WUS) carrying multiple encoded bits based on one or more information bits of a wake-up message. The WUS includes a plurality of signal components, each signal component carrying one or more encoded bits. At least two of the plurality of signal components are received in different frequency segments comprising different sets of frequency resources. At 820, the method includes, in response to the WUS, configuring one or more components of the UE to receive subsequent signals.

In some examples, at least two respective encoded bits based on a same information bit are received in at least two respective different frequency segments. In some examples (e.g., the examples of FIGS. 3 and 4) the plurality of signal components are received in a same set of time domain resources.

In some examples (e.g., the examples of FIGS. 5-7), the plurality of signal components are received in a different set of time domain resources.

In some examples, each encoded bit is modulated with multi-carrier on-off keying (MC-OOK).

In some examples, one or more of the encoded bits are mapped to a sequence on multiple subcarriers of an orthogonal frequency division multiplexing (OFDM) symbol.

Each information bit may be encoded using a repetition code or a block code.

The method may include interleaving the encoded bits according to an interleaving scheme before mapping to the plurality of signal components.

In some examples, segments of the encoded bits are mapped to multiple sets of signal components of the plurality of signal components, each set of signal components occurring in different time domain resources.

In some examples, each encoded bit is modulated with multi-carrier frequency shift-keying (MC-FSK), and the signal component carrying an encoded bit is received in different frequency segments depending on whether the encoded bit is equal to zero or one. In some examples, the plurality of signal components are received in at least two different frequency segments in two different sets of time domain resources, respectively, and a frequency segment used to carry an encoded bit equal to zero in one set of time domain resources is different from the frequency segment used to carry an encoded bit equal to one in another set of time domain resources. In some examples, the plurality of signal components are received in at least two different frequency segments in two different sets of time domain resources, respectively, and a frequency segment used to carry an encoded bit equal to zero in one set of time domain resources is the same as the frequency segment used to carry an encoded bit equal to one in another set of time domain resources.

In some examples, the plurality of signal components are received in different time domain resources, wherein the baseband processor is configured to select an f^{th} frequency segment of F configured frequency segments in each time domain resource of the WUS for monitoring based on a selection function, wherein the selection function is received via dedicated radio resource configuration signaling, a media access control element, a broadcast message, or a system information block (SIB). The selection function may be based on a frequency segment offset determined based on an index of the time domain resource. The index of the time domain resource may be determined with respect to a relative time reference or an absolute time reference. In some examples, the frequency segment offset is determined by multiplying an index of the time domain resource by a configured prime number, based on a pseudo-random sequence, or according to a configured series of values for the frequency segment offset.

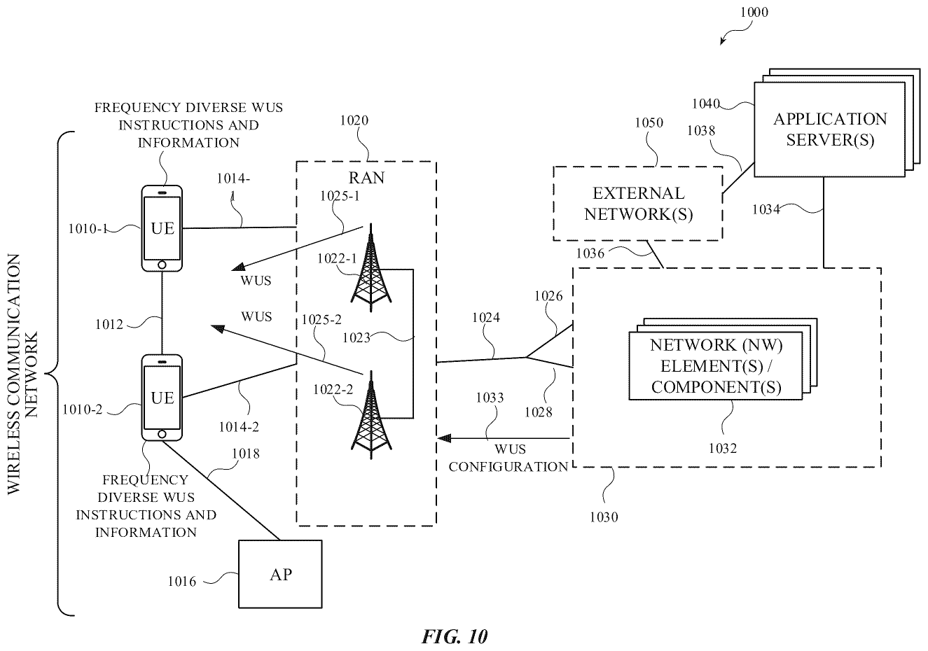

FIG. 9 is a flow diagram outlining an example method 900 for transmitting a WUS. The method 900 may be performed by a base station (e.g., BS or RAN node 1022 of FIG. 10). The method includes, at 910, transmitting a wake-up signal (WUS) carrying multiple encoded bits based on one or more information bits of a wake-up message. The WUS includes a plurality of signal components, each signal component carrying one or more encoded bits. At least two of the plurality of signal components are transmitted in different frequency segments comprising different sets of frequency resources.

In some examples, at least two respective encoded bits based on a same information bit are transmitted in at least two respective different frequency segments. In some examples (e.g., the examples of FIGS. 3 and 4) the plurality of signal components are transmitted in a same set of time domain resources.

In some examples (e.g., the examples of FIGS. 5-7), the plurality of signal components are transmitted in a different set of time domain resources.

In some examples, each encoded bit is modulated with multi-carrier on-off keying (MC-OOK).

In some examples, one or more of the encoded bits are mapped to a sequence on multiple subcarriers of an orthogonal frequency division multiplexing (OFDM) symbol.

Each information bit may be encoded using a repetition code or a block code.

The method may include interleaving the encoded bits according to an interleaving scheme before mapping to the plurality of signal components.

In some examples, segments of the encoded bits are mapped to multiple sets of signal components of the plurality of signal components, each set of signal components occurring in different time domain resources.

In some examples, each encoded bit is modulated with multi-carrier frequency shift-keying (MC-FSK), and the signal component carrying an encoded bit is transmitted in different frequency segments depending on whether the encoded bit is equal to zero or one. In some examples, the plurality of signal components are transmitted in at least two different frequency segments in two different sets of time domain resources, respectively, and a frequency segment used to carry an encoded bit equal to zero in one set of time domain resources is different from the frequency segment used to carry an encoded bit equal to one in another set of time domain resources. In some examples, the plurality of signal components are transmitted in at least two different frequency segments in two different sets of time domain resources, respectively, and a frequency segment used to carry an encoded bit equal to zero in one set of time domain resources is the same as the frequency segment used to carry an encoded bit equal to one in another set of time domain resources.

In some examples, the plurality of signal components are transmitted in different time domain resources, and the method includes selecting an f^{th} frequency segment of F configured frequency segments in each time domain resource of the WUS for carrying a signal component based on a selection function. The selection function may be based on a frequency segment offset determined based on an index of the time domain resource. The index of the time domain resource may be determined with respect to a relative time reference or an absolute time reference. In some examples, the frequency segment offset is determined by multiplying an index of the time domain resource by a configured prime number, based on a pseudo-random sequence, or according to a configured series of values for the frequency segment offset.

As can be seen from the foregoing disclosure, frequency diversity for WUS may be supported for a number of different modulation schemes using the disclosed distributed transmission and/or frequency hopping techniques.

FIG. 10 is an example network 1000 according to one or more implementations described herein. Example network 1000 may include UEs 1010-1, 1010-2, etc. (referred to collectively as “UEs 1010” and individually as “UE 1010”), a radio access network (RAN) 1020, a core network (CN) 1030, application servers 1040, and external networks 1050.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

### Examples

Example 1 is a user equipment (UE), including a baseband processor and a memory, the baseband processor configured to, when executing instructions stored in the memory, cause the UE to: receive a wake-up signal (WUS) carrying multiple encoded bits based on one or more information bits of a wake-up message, the WUS including a plurality of signal components, each signal component carrying one or more encoded bits, wherein at least two of the plurality of signal components are received in different frequency segments including different sets of frequency resources; and in response to the WUS, configure one or more components of the UE to receive subsequent signals.

Example 2 includes the subject matter of example 1, including or omitting optional elements, wherein at least two respective encoded bits based on a same information bit are received in at least two respective different frequency segments.

Example 3 includes the subject matter of example 1, including or omitting optional elements, wherein the plurality of signal components are received in a same set of time domain resources.

Example 4 includes the subject matter of example 1, including or omitting optional elements, wherein the plurality of signal components are received in a different set of time domain resources.

Example 5 includes the subject matter of example 1, including or omitting optional elements, wherein each encoded bit is modulated with multi-carrier on-off keying (MC-OOK).

Example 6 includes the subject matter of example 1, including or omitting optional elements, wherein one or more of the encoded bits are mapped to a sequence on multiple subcarriers of an orthogonal frequency division multiplexing (OFDM) symbol.

Example 7 includes the subject matter of example 1, including or omitting optional elements, wherein each information bit is encoded using a repetition code.

Example 8 includes the subject matter of example 1, including or omitting optional elements, wherein the information bits are encoded using a block code.

Example 9 includes the subject matter of example 8, including or omitting optional elements, wherein the encoded bits are interleaved according to an interleaving scheme before mapping to the plurality of signal components.

Example 10 includes the subject matter of example 8, including or omitting optional elements, wherein segments of the encoded bits are mapped to multiple sets of signal components of the plurality of signal components, each set of signal components occurring in different time domain resources.

Example 11 includes the subject matter of example 1, including or omitting optional elements, wherein each encoded bit is modulated with multi-carrier frequency shift-keying (MC-FSK), further wherein the signal component carrying an encoded bit is received in different frequency segments depending on whether the encoded bit is equal to zero or one.

Example 12 includes the subject matter of example 11, including or omitting optional elements, wherein the plurality of signal components are received in at least two different frequency segments in two different sets of time domain resources, respectively, and further wherein a frequency segment used to carry an encoded bit equal to zero in one set of time domain resources is different from the frequency segment used to carry an encoded bit equal to one in another set of time domain resources.

Example 13 includes the subject matter of example 11, including or omitting optional elements, wherein the plurality of signal components are received in at least two different frequency segments in two different sets of time domain resources, respectively, and further wherein a frequency segment used to carry an encoded bit equal to zero in one set of time domain resources is the same as the frequency segment used to carry an encoded bit equal to one in another set of time domain resources.

Example 14 includes the subject matter of example 1, including or omitting optional elements, wherein the plurality of signal components are received in different time domain resources, wherein the baseband processor is configured to cause the UE to select an f^{th} frequency segment of F configured frequency segments in each time domain resource of the WUS for monitoring based on a selection function, wherein the selection function is received via dedicated radio resource configuration signaling, a media access control element, a broadcast message, or a system information block (SIB).

Example 15 includes the subject matter of example 14, including or omitting optional elements, wherein the selection function is based on a frequency segment offset determined based on an index of the time domain resource.

Example 16 includes the subject matter of example 15, including or omitting optional elements, wherein the index of the time domain resource is determined with respect to a relative time reference.

Example 17 includes the subject matter of example 15, including or omitting optional elements, wherein the index of the time domain resource is determined with respect to an absolute time reference.

Example 18 includes the subject matter of example 14, including or omitting optional elements, wherein frequency segment offset is determined by multiplying an index of the time domain resource by a configured prime number, based on a pseudo-random sequence, or according to a configured series of values for the frequency segment offset.

Example 19 includes the subject matter of example 1, including or omitting optional elements, wherein the baseband processor is configured to cause the UE to receive the WUS with a low power receiver and, in response to the WUS, power a primary receiver to receive the subsequent signals.

Example 20 is a base station comprising a processor and a memory, the processor configured to, when executing instructions stored in the memory, cause the base station to: transmit a wake-up signal (WUS) carrying multiple encoded bits based on one or more information bits of a wake-up message, the WUS including a plurality of signal components, each signal component carrying one or more encoded bits, wherein at least two of the plurality of signal components are transmitted in different frequency segments including different sets of frequency resources.

Example 21 includes the subject matter of example 20, including or omitting optional elements, wherein at least two respective encoded bits based on a same information bit are transmitted in at least two respective different frequency segments.

Example 22 includes the subject matter of example 20, including or omitting optional elements, wherein the plurality of signal components are transmitted in a same set of time domain resources.

Example 23 includes the subject matter of example 20, including or omitting optional elements, wherein the plurality of signal components are transmitted in a different set of time domain resources.

Example 24 includes the subject matter of example 20, including or omitting optional elements, wherein each encoded bit is modulated with multi-carrier on-off keying (MC-OOK).

Example 25 includes the subject matter of example 20, including or omitting optional elements, wherein one or more of the encoded bits are mapped to a sequence on multiple subcarriers of an orthogonal frequency division multiplexing (OFDM) symbol.

Example 26 includes the subject matter of example 20, including or omitting optional elements, wherein each information bit is encoded using a repetition code.

Example 27 includes the subject matter of example 20, including or omitting optional elements, wherein the information bits are encoded using a block code.

Example 28 includes the subject matter of example 26, including or omitting optional elements, wherein the encoded bits are interleaved according to an interleaving scheme before mapping to the plurality of signal components.

Example 29 includes the subject matter of example 26 including or omitting optional elements, wherein segments of the encoded bits are mapped to multiple sets of signal components of the plurality of signal components, each set of signal components occurring in different time domain resources.

Example 30 includes the subject matter of example 20, including or omitting optional elements, wherein each encoded bit is modulated with multi-carrier frequency shift-keying (MC-FSK), further wherein the signal component carrying an encoded bit is transmitted in different frequency segments depending on whether the encoded bit is equal to zero or one.

Example 31 includes the subject matter of example 30, including or omitting optional elements, wherein the plurality of signal components are transmitted in at least two different frequency segments in two different sets of time domain resources, respectively, and further wherein a frequency segment used to carry an encoded bit equal to zero in one set of time domain resources is different from the frequency segment used to carry an encoded bit equal to one in another set of time domain resources.

Example 32 includes the subject matter of example 31, including or omitting optional elements, wherein the plurality of signal components are transmitted in at least two different frequency segments in two different sets of time domain resources, respectively, and further wherein a frequency segment used to carry an encoded bit equal to zero in one set of time domain resources is the same as the frequency segment used to carry an encoded bit equal to one in another set of time domain resources.

Example 33 includes the subject matter of example 20, including or omitting optional elements, wherein the plurality of signal components are transmitted in different time domain resources, wherein the processor is configured to cause the base station to select an f^{th} frequency segment of F configured frequency segments in each time domain resource of the WUS for carrying a signal component based on a selection function.

Example 34 includes the subject matter of example 33, including or omitting optional elements, wherein the selection function is based on a frequency segment offset determined based on an index of the time domain resource.

Example 35 includes the subject matter of example 34, including or omitting optional elements, wherein the index of the time domain resource is determined with respect to a relative time reference.

Example 36 includes the subject matter of example 34, including or omitting optional elements, wherein the index of the time domain resource is determined with respect to an absolute time reference.

Example 37 includes the subject matter of example 33, including or omitting optional elements, wherein frequency segment offset is determined by multiplying an index of the time domain resource by a configured prime number, based on a pseudo-random sequence, or according to a configured series of values for the frequency segment offset.

Example 38 is a method for a user equipment (UE), including: receiving a wake-up signal (WUS) carrying multiple encoded bits based on one or more information bits of a wake-up message, the WUS including a plurality of signal components, each signal component carrying one or more encoded bits, wherein at least two of the plurality of signal components are received in different frequency segments including different sets of frequency resources; and in response to the WUS, configuring one or more components of the UE to receive subsequent signals.

Example 39 includes the subject matter of example 38, including or omitting optional elements, wherein at least two respective encoded bits based on a same information bit are received in at least two respective different frequency segments.

Example 40 includes the subject matter of example 38, including or omitting optional elements, wherein the plurality of signal components are received in a same set of time domain resources.

Example 41 includes the subject matter of example 38, including or omitting optional elements, wherein the plurality of signal components are received in a different set of time domain resources.

Example 42 includes the subject matter of example 38, including or omitting optional elements, wherein segments of the encoded bits are mapped to multiple sets of signal components of the plurality of signal components, each set of signal components occurring in different time domain resources.

Example 43 includes the subject matter of example 38, including or omitting optional elements, wherein each encoded bit is modulated with multi-carrier frequency shift-keying (MC-FSK), further wherein the signal component carrying an encoded bit is received in different frequency segments depending on whether the encoded bit is equal to zero or one.

Example 44 includes the subject matter of example 38, including or omitting optional elements, wherein the plurality of signal components are received in different time domain resources, the method including selecting an f^{th} frequency segment of F configured frequency segments in each time domain resource of the WUS for monitoring based on a selection function, wherein the selection function is received via dedicated radio resource configuration signaling, a media access control element, a broadcast message, or a system information block (SIB), wherein the selection function is based on a frequency segment offset determined based on an index of the time domain resource.

Example 45 includes the subject matter of example 38, including or omitting optional elements, including receiving the WUS with a low power receiver and, in response to the WUS, powering a primary receiver to receive the subsequent signals.

Example 46 is the baseband processor of the UE of any of examples 1-19. Example 47 is the processor of the base station of any of examples 20-37.

Example 48 is a method for a UE including operations performed by the baseband processor of any of examples 1-19.

Example 49 is a method for a base station including operations performed by the processor of any of examples 20-37.

Example 50 is an apparatus for a UE including the baseband processor and the memory of any of examples 1-19.

Example 51 is an apparatus for a base station including the processor of any of examples 20-37.

FIG. 10 is an example network 1000 according to one or more implementations described herein. Example network 1000 may include UEs 1010-1, 1010-2, etc. (referred to collectively as “UEs 1010” and individually as “UE 1010”), a radio access network (RAN) 1020, a core network (CN) 1030, application servers 1040, and external networks 1050.

The systems and devices of example network 1000 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1000 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 1010 may include smartphones (e.g., handheld touchscreen mobile computing devices connectable to one or more wireless communication networks). Additionally, or alternatively, UEs 1010 may include other types of mobile or non-mobile computing devices capable of wireless communications, such as personal data assistants (PDAs), pagers, laptop computers, desktop computers, wireless handsets, watches etc. In some implementations, UEs 1010 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

The connection may include an M2M connection, MTC connection, D2D connection, SL connection, etc. The connection may involve a PC5 interface. In some implementations, UEs 1010 may be configured to discover one another, negotiate wireless resources between one another, and establish connections between one another, without intervention or communications involving RAN node 1022 or another type of network node. In some implementations, discovery, authentication, resource negotiation, registration, etc., may involve communications with RAN node 1022 or another type of network node.

UEs 1010 may use one or more wireless channels 1012 to communicate with one another. As described herein, UE 1010-1 may communicate with RAN node 1022 to request SL resources. RAN node 1022 may respond to the request by providing UE 1010 with a dynamic grant (DG) or configured grant (CG) regarding SL resources. A DG may involve a grant based on a grant request from UE 1010. A CG may involve a resource grant without a grant request and may be based on a type of service being provided (e.g., services that have strict timing or latency requirements). UE 1010 may perform a clear channel assessment (CCA) procedure based on the DG or CG, select SL resources based on the CCA procedure and the DG or CG; and communicate with another UE 1010 based on the SL resources. The UE 1010 may communicate with RAN node 1022 using a licensed frequency band and communicate with the other UE 1010 using an unlicensed frequency band.

UEs 1010 may communicate and establish a connection with (e.g., be communicatively coupled) with RAN 1020, which may involve one or more wireless channels 1014-1 and 1014-2, each of which may comprise a physical communications interface I layer.

A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 1010 may also, or alternatively, connect to access point (AP) 1016 via connection interface 1018, which may include an air interface enabling UE 1010 to communicatively couple with AP 1016. AP 1016 may comprise a wireless local area network (WLAN), WLAN node, WLAN termination point, etc. The connection 1018 may comprise a local wireless connection, such as a connection consistent with any IEEE 702.11 protocol, and AP 1016 may comprise a wireless fidelity (Wi-Fi®) router or other AP. While not explicitly depicted in FIG. 10, AP 1016 may be connected to another network (e.g., the Internet) without connecting to RAN 1020 or CN 1030. The UE 1010 may store frequency diverse WUS instructions and information for receiving and processing WUS according to any of the solutions disclosed with reference to FIGS. 3-9.

RAN 1020 may include one or more RAN nodes 1022-1 and 1022-2 (referred to collectively as RAN nodes 1022, and individually as RAN node 1022) that enable channels 1014-1 and 1014-2 to be established between UEs 1010 and RAN 1020. RAN nodes 1022 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1022 may include a roadside unit (RSU), a transmission reception point (TRxP or TRP), and one or more other types of ground stations (e.g., terrestrial access points). In some scenarios, RAN node 1022 may be a dedicated physical device, such as a macrocell base station, and/or a low power (LP) base station for providing femtocells, picocells or the like having smaller coverage areas, smaller user capacity, or higher bandwidth compared to macrocells. Additionally, or alternatively, one or more of RAN nodes 1022 can be next generation eNBs (i.e., gNBs) that can provide evolved universal terrestrial radio access (E-UTRA) user plane and control plane protocol terminations 1026, 1028 toward UEs 1010, and that can be connected to a 5G core network (5GC) 130 via an NG interface 1024.

Any of the RAN nodes 1022 can terminate an air interface protocol and can be the first point of contact for UEs 1010. In some implementations, any of the RAN nodes 1022 can fulfill various logical functions for the RAN 1020 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 1022 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations are not necessarily limited in this regard. The OFDM signals can comprise a plurality of orthogonal subcarriers. As described herein, the RAN nodes 1022 may be configured by a WUS configuration 1033 on the user or control plane 1026, 1028 from the CN 1030 to transmit WUS 1025 according to any of the solutions disclosed with reference to FIGS. 3-9 to monitor for WUS 1025.

In some implementations, a downlink resource grid may be used for downlink transmissions from any of the RAN nodes 1022 to UEs 1010, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

The RAN nodes 1022 may be configured to communicate with one another via interface 1023. In implementations where the system is an LTE system, interface 1023 may be an X2 interface. In NR systems, interface 1023 may be an Xn interface. The X2 interface may be defined between two or more RAN nodes 1022 (e.g., two or more eNBs/gNBs or a combination thereof) that connect to evolved packet core (EPC) or CN 1030, or between two eNBs connecting to an EPC.

CN 1030 may comprise a plurality of network elements 1032, which are configured to offer various data and telecommunications services to customers/subscribers (e.g., users of UEs 1010) who are connected to the CN 1030 via the RAN 1020. In some implementations, CN 1030 may include an evolved packet core (EPC), a 5G CN, and/or one or more additional or alternative types of CNs. The components of the CN 1030 may be implemented in one physical node or separate physical nodes including components to read and execute instructions from a machine-readable or computer-readable medium (e.g., a non-transitory machine-readable storage medium.

As shown, CN 1030, application servers 1040, and external networks 1050 may be connected to one another via interfaces 1034, 1036, and 1038, which may include IP network interfaces.

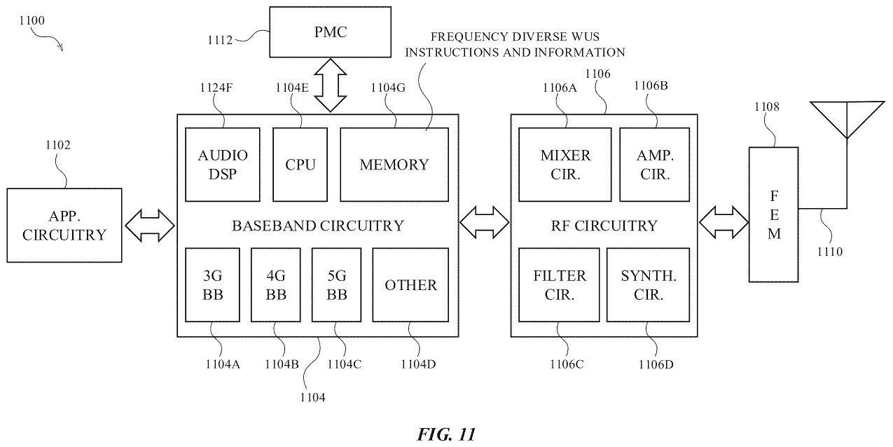

FIG. 11 is a diagram of an example of components of a device according to one or more implementations described herein. In some implementations, the device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. The components of the illustrated device 1100 can be included in a UE or a RAN node. In some implementations, the device 1100 can include fewer elements (e.g., a RAN node may not utilize application circuitry 1102, and instead include a processor/controller to process IP data received from a CN or an Evolved Packet Core (EPC)). In some implementations, the device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for Cloud-RAN (C-RAN) implementations).

The baseband circuitry 1104 can include circuitry such as, but not limited to, one or more single-core or multi-core processors. The baseband circuitry 1104 can include one or more baseband processors or control logic to process baseband signals received from a receive signal path of the RF circuitry 1106 and to generate baseband signals for a transmit signal path of the RF circuitry 1106. Baseband circuitry 1104 can interface with the application circuitry 1102 for generation and processing of the baseband signals and for controlling operations of the RF circuitry 1106. For example, in some implementations, the baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 5G, 6G, etc.).

The baseband circuitry 1104 (e.g., one or more of baseband processors 1104A-D) can handle various radio control functions that enable communication with one or more radio networks via the RF circuitry 1106. In other implementations, some or all of the functionality of baseband processors 1104A-D can be included in modules stored in the memory 1104G and executed via a Central Processing Unit (CPU) 1104E. The radio control functions can include, but are not limited to, signal modulation/demodulation, encoding/decoding, radio frequency shifting, etc. In some implementations, modulation/demodulation circuitry of the baseband circuitry 1104 can include Fast-Fourier Transform (FFT), precoding, or constellation mapping/de-mapping functionality. In some implementations, encoding/decoding circuitry of the baseband circuitry 1104 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1104G may receive and/or store information and instructions for generating and transmitting a WUS (when the device 1100 is a RAN node) or receiving and processing a WUS (when the device is a UE) according to any of the solutions disclosed herein.

In some implementations, the baseband circuitry 1104 can include one or more audio digital signal processor(s) (DSP) 1104F. The audio DSPs 1104F can include elements for compression/decompression and echo cancellation and can include other suitable processing elements in other implementations.

RF circuitry 1106 can enable communication with wireless networks using modulated electromagnetic radiation through a non-solid medium. In various implementations, the RF circuitry 1106 can include switches, filters, amplifiers, etc. to facilitate the communication with the wireless network. RF circuitry 1106 can include a receive signal path which can include circuitry to down-convert RF signals received from the FEM circuitry 1108 and provide baseband signals to the baseband circuitry 1104. RF circuitry 1106 can also include a transmit signal path which can include circuitry to up-convert baseband signals provided by the baseband circuitry 1104 and provide RF output signals to the FEM circuitry 1108 for transmission.

In some implementations, the receive signal path of the RF circuitry 1106 can include mixer circuitry 1106A, amplifier circuitry 1106B and filter circuitry 1106C. RF circuitry 1106 can also include synthesizer circuitry 1106D for synthesizing a frequency for use by the mixer circuitry 1106A of the receive signal path and the transmit signal path.

The RF circuitry 1106 can include analog-to-digital converter (ADC) and digital-to-analog converter (DAC) circuitry and the baseband circuitry 1104 can include a digital baseband interface to communicate with the RF circuitry 1106.

Synthesizer circuitry 1106D of the RF circuitry 1106 can include a divider, a delay-locked loop (DLL), a multiplexer and a phase accumulator.

FEM circuitry 1108 can include a receive signal path which can include circuitry configured to operate on RF signals received from one or more antennas 1110, amplify the received signals and provide the amplified versions of the received signals to the RF circuitry 1106 for further processing. FEM circuitry 1108 can also include a transmit signal path which can include circuitry configured to amplify signals for transmission provided by the RF circuitry 1106 for transmission by one or more of the one or more antennas 1110. In various implementations, the amplification through the transmit or receive signal paths can be done solely in the RF circuitry 1106, solely in the FEM circuitry 1108, or in both the RF circuitry 1106 and the FEM circuitry 1108.

In some implementations, the PMC 1112 can manage power provided to the baseband circuitry 1104. In particular, the PMC 1112 can control power-source selection, voltage scaling, battery charging, or DC-to-DC conversion. The PMC 1112 can often be included when the device 1100 is capable of being powered by a battery, for example, when the device is included in a UE. The PMC 1112 can increase the power conversion efficiency while providing desirable implementation size and heat dissipation characteristics.

While FIG. 11 shows the PMC 1112 coupled only with the baseband circuitry 1104. However, in other implementations, the PMC 1112 may be additionally or alternatively coupled with, and perform similar power management operations for, other components such as, but not limited to, application circuitry 1102, RF circuitry 1106, or FEM circuitry 1108.

In some implementations, the PMC 1112 can control, or otherwise be part of, various power saving mechanisms of the device 1100. For example, if the device 1100 is in an RRC_Connected state, where it is still connected to the RAN node as it expects to receive traffic shortly, then it can enter a state known as Discontinuous Reception Mode (DRX) after a period of inactivity. During this state, the device 1100 can power down for brief intervals of time and thus save power. During these intervals the device 1100 may periodically power up a low power receiver (see FIG. 1A) to monitor for a WUS.

If there is no data traffic activity for an extended period of time, then the device 1100 can transition off to an RRC_Idle state, where it disconnects from the network and does not perform operations such as channel quality feedback, handover, etc. The device 1100 goes into a very low power state and it performs paging where again it periodically wakes up to listen to the network and then powers down again. During these intervals the device 1100 may periodically power up a low power receiver (see FIG. 1A) to monitor for a WUS. The device 1100 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable. In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. A user equipment (UE), comprising a baseband processor and a memory, the baseband processor configured to, when executing instructions stored in the memory, cause the UE to:
receive a wake-up signal (WUS) carrying multiple encoded bits based on one or more information bits of a wake-up message, the WUS comprising a plurality of signal components, each signal component carrying one or more encoded bits, wherein at least two of the plurality of signal components are received in different frequency segments comprising different sets of frequency resources; and
in response to the WUS, configure one or more components of the UE to receive a subsequent signal.

2. The UE of claim 1, wherein at least two respective encoded bits based on a same information bit are received in at least two respective different frequency segments.

3. The UE of claim 1, wherein the plurality of signal components are received in a same set of time domain resources.

4. The UE of claim 1, wherein the plurality of signal components are received in a different set of time domain resources.

5. The UE of claim 1, wherein each information bit is encoded using a repetition code.

6. The UE of claim 1, wherein the information bits are encoded using a block code.

7. The UE of claim 1, wherein each encoded bit is modulated with multi-carrier frequency shift-keying (MC-FSK), further wherein the signal component carrying an encoded bit is received in different frequency segments depending on whether the encoded bit is equal to zero or one.

8. The UE of claim 7, wherein the plurality of signal components are received in at least two different frequency segments in two different sets of time domain resources, respectively, and further wherein a frequency segment used to carry an encoded bit equal to zero in one set of time domain resources is different from the frequency segment used to carry an encoded bit equal to one in another set of time domain resources.

9. The UE of claim 7, wherein the plurality of signal components are received in at least two different frequency segments in two different sets of time domain resources, respectively, and further wherein a frequency segment used to carry an encoded bit equal to zero in one set of time domain resources is the same as the frequency segment used to carry an encoded bit equal to one in another set of time domain resources.

10. The UE of claim 1, wherein the plurality of signal components are received in different time domain resources, wherein the baseband processor is configured to cause the UE to select an f^{th} frequency segment of F configured frequency segments in each time domain resource of the WUS for monitoring based on a selection function, wherein the selection function is received via dedicated radio resource configuration signaling, a media access control element, a broadcast message, or a system information block (SIB).

11. The UE of claim 10, wherein the selection function is based on a frequency segment offset determined based on an index of the time domain resource.

12. The UE of claim 10, wherein frequency segment offset is determined by multiplying an index of the time domain resource by a configured prime number, based on a pseudo-random sequence, or according to a configured series of values for the frequency segment offset.

13. A base station, comprising a memory and a processor, the processor configured to, when executing instructions stored in the memory, cause the base station to:
transmit a wake-up signal (WUS) carrying multiple encoded bits based on one or more information bits of a wake-up message, the WUS comprising a plurality of signal components, each signal component carrying one or more encoded bits, wherein at least two of the plurality of signal components are transmitted in different frequency segments comprising different sets of frequency resources.

14. The base station of claim 13, wherein segments of the encoded bits are mapped to multiple sets of signal components of the plurality of signal components, each set of signal components occurring in different time domain resources.

15. The base station of claim 13, wherein the plurality of signal components are transmitted in different time domain resources, wherein the processor is configured to cause the base station to select an f^{th} frequency segment of F configured frequency segments in each time domain resource of the WUS for carrying a signal component based on a selection function.

16. The base station of claim 15, wherein frequency segment offset is determined by multiplying an index of the time domain resource by a configured prime number, based on a pseudo-random sequence, or according to a configured series of values for the frequency segment offset.

17. A baseband processor configured to, when executing instructions stored in a memory, perform operations comprising:
receiving a wake-up signal (WUS) carrying multiple encoded bits based on one or more information bits of a wake-up message, the WUS comprising a plurality of signal components, each signal component carrying one or more encoded bits, wherein at least two of the plurality of signal components are received in different frequency segments comprising different sets of frequency resources; and
in response to the WUS, configuring one or more components of a UE to receive a subsequent signal.

18. The baseband processor of claim 17, wherein at least two respective encoded bits based on a same information bit are received in at least two respective different frequency segments.

19. The baseband processor of claim 17, wherein the plurality of signal components are received in a same set of time domain resources.

20. The baseband processor of claim 17, wherein segments of the encoded bits are mapped to multiple sets of signal components of the plurality of signal components, each set of signal components occurring in different time domain resources.
